(19) United States
(12) Patent Application Publication
(10) Pub. No.: US 2005/0178516 A1
(43) Pub. Date: Aug. 18, 2005

(54) Speaker component, method of manufacturing the same and speaker apparatus including the same

(75) Inventors: Hideo Sekikawa, Yamagata (JP); Kazuharu Kawata, Yamagata (JP); Toshihiro Ishigaki, Yamagata (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION; MOGAMI DENKI CORPORATION

(21) Appl. No.: 11/055,680

(22) Filed: Feb. 11, 2005

(30) Foreign Application Priority Data
Feb. 13, 2004 (JP) P2004-037394

(51) Int. Cl. H04R 7/02; H04R 31/00; D21H 17/00

(52) U.S. Cl. 162/159; 162/135; 162/204; 181/199; 381/337

(57) ABSTRACT

To give solution to a problem that a fire-retarded speaker component has a high hygroscopicity and thus exhibits deteriorated acoustic properties, the speaker component undergoes strength drop, elastic modulus drop and internal loss due to fire retardant and the increase of the number of treatment steps adds to manufacturing cost. A speaker component formed by a paper product including a triphenyl phosphate fire retardant is used.

### CROSS-REFERENCE TO RELATED APPLICATION

The invention claims priority to Japanese Patent Application No. JP 2004-037394 filed on Feb. 13, 2004. The disclosure of the prior application is incorporated herein by reference in its entirety.

### BACKGROUND OF THE INVENTION

1. Field of the Invention

The present invention relates to a speaker component, a method of manufacturing the speaker component and a speaker apparatus including the speaker component.

2. Description of the Related Art

In a speaker apparatus such as electrodynamic speaker, a speaker component such as diaphragm configuring the speaker apparatus may ignite due to abnormal temperature rise of a lead wire caused by excess current.

For example, DC current is applied to the speaker apparatus when an amplifier is damaged, a voice coil is abnormally heated. Then, the lead wire breaks and a spark occurs at the broken part of the lead wire, causing a fixed portion of the lead wire to ignite. The fire can extend to the entire speaker apparatus, including the diaphragm and so on (refer to JP-A-2000-115885).

It has been strongly desired to enhance heat resistance and fire retardancy of the speaker components (e.g., diaphragm).

In order to enhance the heat resistance and the fire retardancy of the speaker components, a diaphragm which has been subjected to various fire retardation treatments are used in speaker apparatuses (refer to JP-A-62-150995).

### SUMMARY OF THE INVENTION

However, the speaker components (e.g., diaphragm) which have been subjected to fire retardation treatments in a conventional art are a product of paper making of fire retardant fiber such as cellulose phosphate fiber. Alternatively, a paper product has been treated with a fire retardant such as phosphate-based compound. Thus, the conventional art fire retardant speaker components have a high hygroscopicity.

Accordingly, the speaker components (e.g., diaphragm) absorb moisture in the air and then soften, so that acoustic properties are deteriorated.

Further, since the presence of a fire retardant such as phosphate-based compound prevents bonding of pulp of fiber, adverse effects such as strength drop, elasticity modulus drop and deterioration of acoustic properties such as internal loss are exerted on the speaker components (e.g., diaphragm). In order to eliminate these adverse effects, it is necessary that a paper product be impregnated with a resin solution such as melamine resin at a separate step.

In the conventional art method for the manufacture of speaker components (e.g., diaphragm), it is required that several steps be effected for resin treatment for fire retardation and reinforcement, causing an increase of the number of treatment steps that adds to manufacturing cost.

The problems that the invention is to solve are that a speaker component (e.g., diaphragm) which has been subjected to fire retardation in the conventional art has a high hygroscopicity and thus exhibits deteriorated acoustic properties, the speaker component (e.g., diaphragm) undergoes strength drop, elastic modulus drop and internal loss due to fire retardant and the increase of the number of treatment steps adds to manufacturing cost in a speaker component, a method for manufacturing the speaker component and a speaker apparatus including the component.

According to an embodiment of the invention, there is provided a speaker component including: a paper product made of a triphenyl phosphate fire retardant.

According to an embodiment of the invention, there is provided a method of manufacturing a speaker component including steps of: forming a paper product by paper making; impregnating the paper product with a fire retardant treatment containing a triphenyl phosphate fire retardant; and finishing the paper product thus impregnated into a predetermined shape.

According to an embodiment of the invention, there is provided a method of manufacturing a speaker component including steps of: forming a paper product by paper making; coating the paper product with a fire retardant treatment containing a triphenyl phosphate fire retardant as a coating solution; and finishing the paper product thus coated into a predetermined shape.

According to an embodiment of the invention, there is provided a method of manufacturing a speaker component including steps of: grinding a triphenyl phosphate fire retardant; dispersing the triphenyl phosphate fire retardant thus ground in a paper making slurry; subjecting the paper making slurry to paper making to form a paper product; and finishing the paper product into a predetermined shape.

According to an embodiment of the invention, there is provided a speaker apparatus including: a speaker component including a paper product made of a triphenyl phosphate fire retardant.

### BRIEF DESCRIPTION OF THE DRAWING

These and other objects and advantages of this invention will become more fully apparent from the following detailed description taken with the accompanying drawings in which:

FIG. 1 is a schematic diagram illustrating the configuration of an example of speaker component including a speaker component according to an embodiment of the invention;

FIG. 2 is a manufacture flow chart illustrating a method of manufacturing a speaker component according to an embodiment of the invention;

FIG. 3 is a manufacture flow chart illustrating another method of manufacturing a speaker component according to an embodiment of the invention;

FIG. 4 is a manufacture flow chart illustrating a further method of manufacturing a speaker component according to an embodiment of the invention;

FIG. 5 is a diagram illustrating a method for dissolving a solid fire retardant in Example 3 of the invention;

FIG. 6 is a diagram illustrating a method for spreading a fire retardant treatment over a diaphragm in Example 3 of the invention;

FIG. 7 is a front view illustrating the diaphragm which has been coated with the fire retardant treatment according to the coating method of FIG. 6; and

FIG. 8 is a front view illustrating the diaphragm which has been coated with the fire retardant treatment using a brush according to the coating method of FIG. 4.

### DETAILED DESCRIPTION OF THE PREFERRED EMBODIMENTS

Embodiments of the invention will be described with reference to the accompanying drawings.

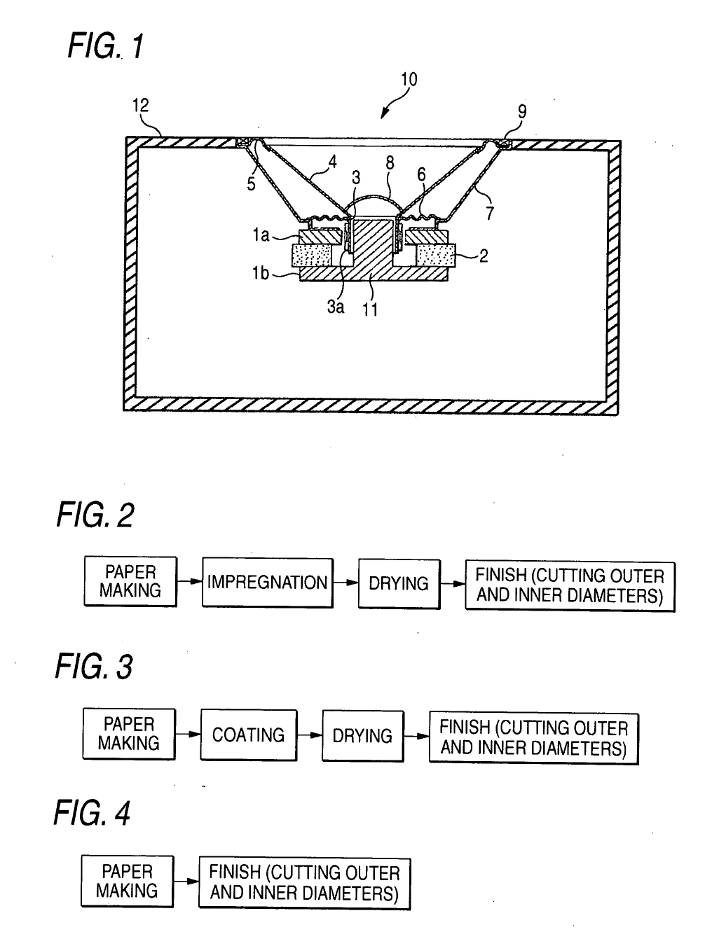

FIG. 1 is a schematic diagram illustrating the configuration of a speaker apparatus including a speaker component according to an embodiment of the present invention.

A speaker apparatus 10 according to the embodiment is configured with various speaker components.

Examples of these speaker components include an annular yoke 1, an annular magnet 2, a voice coil 3a, a bobbin 3, a diaphragm 4, an edge 5, a damper 6, a flame 7, a center cap 8, a packing 9 and a cabinet 12 as shown in FIG. 1.

A gist of the configuration of the speaker apparatus 10 including the various speaker components will be described.

The annular yoke 1 includes an upper plate 1a and a lower plate 1b between which the annular magnet 2 is provided interposed.

The annular yoke 1 and the annular magnet 2 configure a magnetic circuit. A bobbin 3 having a voice coil 3a wound thereon is provided around a center pole 11 at a central portion of the magnetic circuit.

The bobbin 3 is retained by the flame 7 via the damper 6.

The diaphragm 4 is conical and has a sound reproducing capability for transmitting oscillation of the voice coil 3a to the air. The diaphragm 4 is retained by an edge of the flame 7 at the circumference thereof via the edge 5.

The diaphragm 4 has the center cap 8 attached to the central portion thereof. The edge 5 has a packing 9 attached to a circumference thereof.

The cabinet 12 has a speaker main body including the various speaker components attached thereto and functions as a baffle plate or speaker box.

In the speaker apparatus 10 according to the embodiment, at least one of the various speaker components, i.e., the diaphragm 4, the edge 5, the center cap 8, the bobbin 3, the damper 6, the cabinet 12 is formed by a paper product including a triphenyl phosphate fire retardant.

The chemical structural formula of triphenyl phosphate ((C₆H₅O)₃PO)) is as follows.

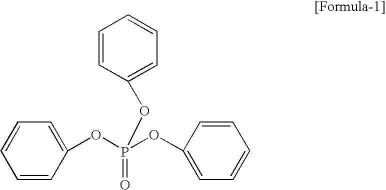

Three examples of the method of manufacturing the speaker component will be described hereinafter in connection with the manufacture flow sheet of FIG. 2 with reference to a case where the speaker component formed by a paper product including a triphenyl phosphate fire retardant is the diaphragm 4.

(Manufacturing Method 1)

As shown in FIG. 2, a fiber such as natural fiber, chemical fiber and inorganic fiber is subjected to paper making to obtain a conical paper product. After dried, the paper product is then impregnated with a fire retardant treatment obtained by dissolving a triphenyl phosphate fire retardant in a solvent.

The paper product thus impregnated is then dried or subjected to hot air drying. When thoroughly dried, the paper product is then finished into a shape which can be used as the diaphragm 4. For example, the conical paper product is cut at a circumference thereof to have a predetermined outer diameter and cut at a center thereof to form a hole having a diameter corresponding to that of the bobbin 3. Thus, the diaphragm 4 is formed.

In the manufacturing method, the triphenyl phosphate fire retardant itself may be heated to its melting point without the solvent to obtain a fire retardant treatment with which the paper product is then impregnated.

(Manufacturing Method 2)

As shown in FIG. 3, a fiber such as natural fiber, chemical fiber and inorganic fiber is subjected to paper making to obtain a conical paper product.

After dried, the paper product is then coated with a fire retardant treatment obtained by dissolving a triphenyl phosphate fire retardant in a solvent or heating the triphenyl phosphate fire retardant to its melting point as a coating solution (The coating solution is spread over a surface of the conical paper product thus dried using a brush or the like).

Alternatively, a mixture of a powder obtained by grinding the triphenyl phosphate fire retardant with a binder-like or adhesive resin or an inorganic material such as cement may be used as a coating solution.

The paper product thus coated is then dried or subjected to hot air drying. When thoroughly dried, the paper product is then finished into a shape which can be used as a diaphragm 4. For example, the conical paper product is cut at the circumference thereof to have a predetermined outer diameter and cut at the center thereof to form a hole having the diameter corresponding to that of the bobbin 3. Thus, the diaphragm 4 is formed.

Thus, in accordance with the manufacturing method 2, speaker components or a part thereof, which cannot be impregnated, can be easily subjected to fire retardation.

(Manufacturing Method 3)

As shown in FIG. 4, a product of grinding of a triphenyl phosphate fire retardant in addition to a fiber such as natural fiber, chemical fiber and inorganic fiber is dispersed in a paper making slurry which is then subjected to paper making to obtain a conical paper product.

After dried, the paper product is then finished into a predetermined shape which can be used as the diaphragm 4. For example, the conical paper product is cut at the circumference thereof to have a predetermined outer diameter and cut at the center thereof to form a hole having the diameter corresponding to that of the bobbin 3. Thus, the diaphragm 4 is formed.

In the manufacturing methods 1 to 3, in order to exhibit fire retardancy more effectively, a halogen-based fire retardant, a phosphorus-based fire retardant, an inorganic fire retardant, etc. may be incorporated in the material or may be used at separate treatment steps.

In order to enhance the fixability of the fire retardancy-providing components to the paper product made of woodpulp or the like, a thermosetting resin, thermoplastic resin or the like may be incorporated in the material or may be used at separate treatment steps.

The diaphragm 4 (speaker component) manufactured by the manufacturing methods 1 to 3 includes a triphenyl phosphate fire retardant and thus exhibits a good fire retardancy and a low hygroscopicity and can difficultly soften. Thus, a diaphragm causing no deterioration of acoustic properties can be obtained by a simple manufacturing method.

While the manufacturing methods 1 to 3 have been described with reference to the method of manufacturing the diaphragm 4, other speaker components such as edge 5, center cap 8, bobbin 3, damper 6 and cabinet 12 can be manufactured by the same method using a triphenyl phosphate fire retardant. Thus, speaker components which exhibit a good fire retardancy and a low hygroscopicity and can difficultly soften and thus cause no deterioration of acoustic properties can be obtained by a simple manufacturing method.

For the various speaker components, the triphenyl phosphate fire retardants can be used in a following manner.

For the edge 5, a cloth material may be impregnated with a triphenyl phosphate fire retardant and the coating material or rubber may include a triphenyl phosphate fire retardant incorporated therein.

For the center cap 8, a material such as paper and cloth may be processed in the same manner as for diaphragm. Alternatively, the triphenyl phosphate fire retardant may be kneaded with the film-forming material or may be added to the base resin.

For the bobbin 3, a craft bobbin may be impregnated with the triphenyl phosphate fire retardant. Alternatively, the triphenyl phosphate fire retardant may be kneaded with the film-forming material. Alternatively, the triphenyl phosphate fire retardant may be added to the coating material.

For the damper 6, the cloth material may be impregnated with the triphenyl phosphate fire retardant. Alternatively, the triphenyl phosphate fire retardant may be added to a thermoplastic resin (e.g., phenolic resin).

For the cabinet 12, the triphenyl phosphate fire retardant may be kneaded with the resin. Alternatively, the triphenyl phosphate fire retardant may be added to the surface coating agent.

Alternatively, all the speaker components may be coated with a resin having a triphenyl phosphate fire retardant incorporated therein.

The embodiments of the invention will be further described in the following examples.

### EXAMPLE 1

| | |
|---|---|
| Wood pulp (conifer craft pulp) | 90 parts by weight |
| Chemical fiber (aramide fiber having | 10 parts by weight |
| a length of about 2 mm) | |

The components were subjected to paper making according to the manufacturing method 1 to obtain a paper product which is a substrate of diaphragm 4.

Further, the following components were prepared.

| | |
|---|---|
| Triphenyl phosphate | 20 parts by weight |
| Solvent | 80 parts by weight |

The solid triphenyl phosphate was then dissolved in the solvent to obtain a fire retardant treatment.

Subsequently, the paper product thus obtained was thoroughly and uniformly impregnated with the fire retardant treatment, and then hot-air dried in an 80° C. atmosphere for 10 minutes. Thus, a fire retardant diaphragm (product of Example 1) was obtained.

The fire retardant diaphragm thus prepared (the product of Example 1) and a diaphragm including a conventional art fire retardant (the conventional art product) and a diaphragm free of fire retardant (un-fire retarded product) for comparison were then each subjected to hygroscopicity test.

For the hygroscopicity test, a specimen was stood in a high temperature of 40° C. and humidity 90% RH atmosphere for 24 hours. The change of the weight of the various diaphragms from before to after test was then determined.

The results of weight change were as follows:

| | |
|---|---|
| Un-fire retarded product | 12% rise |
| Conventional art product | 16% rise |
| Product of Example 1 | 9% rise |

It was thus confirmed that the product of Example 1 exhibits a hygroscopicity of about half that of the conventional art product.

As the paper product there may be used 100 parts by weight of a wood pulp. In general, a paper product may include a fire retardant or incombustible fiber incorporated therein to enhance fire retardancy thereof. As the solvent there was used a mixed solvent including an aromatic hydrocarbon.

The mixing ratio of triphenyl phosphate to solvent is merely exemplary. Even when the concentration of the triphenyl phosphate is about 5 parts by weight at minimum, the resulting paper product exhibits sufficient fire retardancy as compared with untreated products.

In Example 1, since the saturated concentration of triphenyl phosphate is about 60 parts by weight, the concentration of triphenyl phosphate can be adjusted to fall within the range of from 5 to 60 parts by weight taking into account working efficiency to obtain desired fire retardancy.

For the confirmation of fire retardancy, the product of Example 1 was subjected to fire retardant test. As a result, the specimen which had been withdrawn from flame showed no afterflaming due to carbonation and self-extinguishing properties and thus was confirmed to have conformance with UL Specification 94-V-0 to V-1 and hence an excellent fire retardancy.

### EXAMPLE 2

A wood pulp and a chemical fiber were used in the same amount as in Example 1 to obtain a paper product.

Further, the following components were prepared.

| | |
|---|---|
| Triphenyl phosphate | 20 parts by weight |
| Phosphorus-based fire retardant | 10 parts by weight |
| Acrylic acid ester resin | 20 parts by weight |
| Solvent | 50 parts by weight |

The liquid phosphorus-based fire retardant and acrylic acid ester resin were dissolved in the solvent. The solid triphenyl phosphate was then dissolved in the solution to obtain a fire retardant treatment.

Subsequently, the paper product was dissolved in the fire retardant treatment, withdrawn from the fire retardant treatment, and then hot-air dried in an 80° C. atmosphere for 10 minutes in the same manner as in Example 1 to obtain a fire retardant diaphragm.

The fire retardant diaphragm thus prepared (the product of Example 2) and a diaphragm including the conventional art fire retardant (the conventional art product) and a diaphragm free of fire retardant (the un-fire retarded product) for comparison were then each subjected to hygroscopicity test in the same manner as in Example 1.

The results of the hygroscopicity test will be givenbelow.

The results of weight change were as follows:

| | |
|---|---|
| Un-fire retarded product | 12% rise |
| Conventional art product | 16% rise |
| Product of Example 2 | 8% rise |

As can be seen in the results shown above, the product of Example 2 exhibits a further drop of hygroscopicity as compared with the product of Example 1.

For the confirmation of fire retardancy, the product of Example 2 was subjected to fire retardant test. As a result, the specimen which had been withdrawn from flame showed no afterflaming due to carbonation and self-extinguishing properties and thus was confirmed to have conformance with UL Specification 94-V-0 to V-1 and hence an excellent fire retardancy.

For the confirmation of flammability, the test specimen was subjected to test in the same manner as in Example 1. As a result, the product of Example 2 showed excellent fire retardancy similar to that of the product of Example 1.

### EXAMPLE 3

In Example 3, 100 parts by weight of a wood pulp (conifer craft pulp) were used to obtain a paper product.

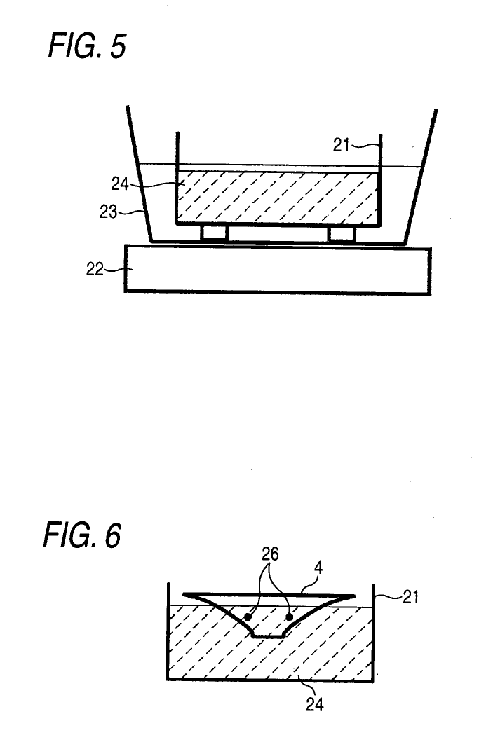

As shown in FIG. 5, a vessel 21 having 100 parts by weight of a triphenyl phosphate received therein was dipped in a hot bath 23 which had been heated to 50° C. by a heater 22. In this manner, a fire retardant treatment 24 which is a liquid triphenyl phosphate was obtained.

Subsequently, a conical diaphragm 4 which is a formed product of the paper product was dipped in the fire retardant treatment 24 in the vessel 21 over a predetermined range of from the central portion to an eyelet hole 26 as shown in FIG. 6.

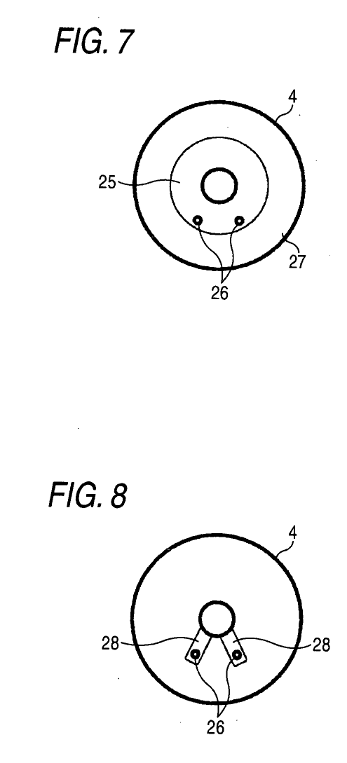

Subsequently, the fire retardant treatment 24 which had been spread over the diaphragm 4 by this dipping was hot-air dried in an 80° C. atmosphere for 5 minutes. In this manner, a diaphragm 4 having a fire-retarded portion 25 and un-fire retarded portion 27 was obtained as shown in FIG. 7.

In the speaker apparatus 10 including a lead wire extending through an eyelet hole provided on the diaphragm 4 for introducing signal current into the voice coil, excess current flowing through the lead wire can cause abnormal heat generation of the eyelet hole.

Accordingly, the fire retardation of the diaphragm over the range extending close to the eyelet hole 26 makes it possible to prevent ignition and combustion.

### EXAMPLE 4

As shown in FIG. 8, in Example 4, the diaphragm 4 made of the same paper produced by as in Example 3 was coated with 100 parts by weight of the same triphenyl phosphate fire retardant as used in Example 3 on a predetermined area 28 thereof.

The predetermined area 28 is a wiring area into which the lead wire (which is connected to the eyelet hole) from the area close to the eyelet hole 26 is introduced (which can be brought into contact with the lead wire).

In this arrangement, the combustion of the diaphragm 4 by the heat generated by excess current flowing through the lead wire can be avoided.

While the spreading of the fire retardant treatment was carried out using a brush, any other known coating methods may be employed.

In Examples 3 and 4, a product of melting of 100 parts by weight of a triphenyl phosphate was used. In this manner, fire retardancy was given depending on the substrate used. The products of Examples 3 and 4 were samples obtained by fire-retarding only part of the diaphragm 4 and thus were not subjected to measurement of hygroscopicity.

In the fire retardant treatments described in Examples 1 and 2, the mixing ratio of triphenyl phosphate fire retardant, acrylic acid ester resin and solvent have the following upper limit and lower limit allowable for fire retarding effect.

In Example 1:

| | Upper limit | Lower limit |
|---|---|---|
| Triphenyl phosphate | 50 parts by weight | 20 parts by weight |
| fire retardant | | |
| Solvent | 80 parts by weight | 50 parts by weight |

In Example 2:

| | Upper limit | Lower limit |
|---|---|---|
| Triphenyl phosphate | 50 parts by weight | 20 parts by weight |
| fire retardant | | |
| Phosphorus-based | 10 parts by weight | 0 parts by weight |
| fire retardant | | |
| Acrylic acid ester | 20 parts by weight | 0 parts by weight |
| resin | | |
| Solvent | 50 parts by weight | 20 parts by weight |

When the upper limit and lower limit are exceeded, the following phenomena occur.

In some detail, when the amount of the triphenyl phosphate exceeds 60 parts by weight, which is the saturated concentration thereof, the resulting weight of the paper product is excessive. When the amount of the phosphorus-based fire retardant exceeds 10 parts by weight, the resulting paper product exhibits a high hygroscopicity. When the amount of the acrylic acid ester resin exceeds 20 parts by weight or the amount of the solvent exceeds 50 parts by weight, the resulting paper product can easily ignite.

Accordingly, when the amount of these components are predetermined within the above defined range between the upper limit and the lower limit such that desired hygroscopicity, fire retardancy, weight, etc. can be obtained, the optimum fire retardant treatment depending on the kind of the paper product can be obtained.

As detailed above, the speaker components according to the embodiments each are formed by a paper including a triphenyl phosphate fire retardant.

Since this fire retardant exhibits a low hygroscopicity, the deterioration of acoustic properties of the speaker components (e.g., diaphragm) due to fire retardant can be prevented. Further, the occurrence of reduction of strength or elastic modulus of the speaker components (e.g., diaphragm) can be prevented. Moreover, desired fire retardancy can be obtained even if the number of treatment steps required for the manufacture of the speaker components (e.g., diaphragm) is not increased.

In the speaker apparatus 10 according to the embodiments, one or more of bobbin 3, diaphragm 4, damper 6, edge 5, center cap 8 and cabinet 12 are formed by a paper product including a triphenyl phosphate fire retardant.

In this arrangement, the hygroscopicity of the various components configuring the speaker apparatus can be effectively suppressed as compared with the conventional art products. A sufficient fire retarding effect can be exerted without deteriorating the acoustic properties of the speaker apparatus.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A speaker component comprising:
a paper product made of a triphenyl phosphate fire retardant.

2. The speaker component according to claim 1, wherein the paper product is impregnated with a fire retardant treatment containing a triphenyl phosphate fire retardant.

3. The speaker component according to claim 1, wherein the paper product is coated with a fire retardant treatment containing a triphenyl phosphate fire retardant as a coating solution.

4. The speaker component according to claim 1, wherein the paper product is obtained by grinding the triphenyl phosphate fire retardant, and then dispersing the triphenyl phosphate fire retardant thus ground in a paper making slurry.

5. The speaker component according to claim 1, wherein the paper product includes at least one of a diaphragm, an edge, a center cap, a bobbin, a damper and a cabinet.

6. A method of manufacturing a speaker component comprising steps of:
forming a paper product by paper making;
impregnating the paper product with a fire retardant treatment containing a triphenyl phosphate fire retardant; and
finishing the paper product thus impregnated into a predetermined shape.

7. A method of manufacturing a speaker component comprising steps of:
forming a paper product by paper making;
coating the paper product with a fire retardant treatment containing a triphenyl phosphate fire retardant as a coating solution; and
finishing the paper product thus coated into a predetermined shape.

8. A method of manufacturing a speaker component comprising steps of:
grinding a triphenyl phosphate fire retardant;
dispersing the triphenyl phosphate fire retardant thus ground in a paper making slurry;
subjecting the paper making slurry to paper making to form a paper product; and
finishing the paper product into a predetermined shape.

9. A speaker apparatus comprising:
a speaker component including a paper product made of a triphenyl phosphate fire retardant.

10. The speaker apparatus according to claim 9, wherein the paper product is impregnated with a fire retardant treatment containing a triphenyl phosphate fire retardant.

11. The speaker apparatus according to claim 9, wherein the paper product is coated with a fire retardant treatment containing a triphenyl phosphate fire retardant as a coating solution.

12. The speaker apparatus according to claim 9, wherein the paper product is obtained by grinding the triphenyl phosphate fire retardant, and then dispersing the triphenyl phosphate fire retardant thus ground in a paper making slurry.

13. The speaker apparatus according to claim 9, wherein the paper product includes at least one of a diaphragm, an edge, a center cap, a bobbin, a damper and a cabinet.
